(19) United States
(12) Patent Application Publication
(10) Pub. No.: US 2022/0038510 A1
(43) Pub. Date: Feb. 3, 2022

(54) System and Method for Providing Remote Attendance to a Live Event

(71) Applicants: John Alden Ross, Athens, GA (US); Michael Sellmer Schersten, Ypsilanti, MI (US)

(72) Inventors: John Alden Ross, Athens, GA (US); Michael Sellmer Schersten, Ypsilanti, MI (US)

(21) Appl. No.: 17/393,216

(22) Filed: Aug. 3, 2021

Related U.S. Application Data
(60) Provisional application No. 63/060,267, filed on Aug. 3, 2020.

(51) Int. Cl. H04L 29/06; H04N 21/2187; H04N 21/4788; H04N 21/442

(52) U.S. Cl. CPC H04L 65/1073; H04N 21/2187; H04L 65/1069; H04N 21/44226; H04N 21/4788

(57) ABSTRACT

A system and method for providing remote attendance to a live event utilizes an innovative audience management system that is designed to provide real-time fan feedback to live events while incorporating other problem-solving features. The method is ideally implemented upon user mobile and personal computing (PC) devices, thereby allowing a user to interact with an event from a variety of locations at the user's convenience. A grouping system enables groups of friends or affiliated fans to join together and share dialogue internally, achieving similar effects as a private box at a stadium or other event venue. Live multimedia feedback allows the players to hear the true reactions of their fans, thus eliminating the need for artificial fan noise to be added to a venue. Such communication further enables users to provide feedback other than audio and video, such as textual and emoji responses, in real-time to events as they unfold.

The current application claims a priority to the U.S. Provisional Patent application Ser. No. 63/060,267 filed on Aug. 3, 2020.

### FIELD OF THE INVENTION

The present invention relates generally to a software application for allowing interactive remote participation in live events and entertainment. More specifically, the system and method for providing remote attendance to a live event relates to software that allows groups of fans, connected by social media, to respond vocally to live events broadcast on TV/Internet/radio and have their united response (cheers, jeers, or tears) be broadcast in near real time into the venue so that the performers can hear their fans' reactions.

### BACKGROUND OF THE INVENTION

A system that presents live online audience for live events broadcast on TV/Internet/radio is in demand. Many groups of individuals may qualify as an audience, including fans of TV shows or viewers of live sports and other live entertainment. At a typical college football game, for example, fans may meet up with friends to tailgate before the game, then sit together at the stadium, chatting, cheering, and enjoying the game together. Such interactions were commonplace before health restrictions from the COVID-19 pandemic were enforced upon the populace.

Unfortunately, such activities are impossible when an event is closed to spectators. There can be many reasons to close a facility for events, such as maintenance or security; in such cases, people can sometimes listen to or watch a live event remotely, via radio, television, or online. However, a remote audience is often limited to observing a live event without interacting with it. Audience members may not give feedback such as cheers. In some situations, people can make telephone calls or send their written opinion to the broadcaster or organizer, but such feedback can be delayed and may not directly and instantaneously influence the event itself.

Today, due in large part to the COVID-19 pandemic, large crowds may not be permitted to fill event venues. Many professional and college sports will be played without spectators in the stands for the foreseeable future as a result. Fans may therefore be isolated at home, watching games without the noise of a crowd. What is needed is a system that can allow fans to engage with their live entertainment media remotely, thus simultaneously increasing audience engagement and avoiding the potentially-devastating consequences of overfilling event venues during a pandemic.

The present invention addresses these issues. A method for providing remote attendance to a live event utilizes an innovative audience management system that is designed to provide real-time fan feedback to live events while incorporating other problem-solving features. The present invention is ideally implemented upon user mobile and personal computing (PC) devices, thereby allowing a user to interact with an event from a variety of locations at the user's convenience. A grouping system enables groups of friends or affiliated fans to join together and share dialogue internally, achieving similar effects as a private box at a stadium or other event venue. Live feedback allows the players to hear the true reactions of their fans, thus eliminating the need for artificial fan noise to be added to a venue.

### BRIEF DESCRIPTION OF THE DRAWINGS

FIG. 1 is a block diagram illustrating the system of the present invention.

FIG. 2 is a flowchart illustrating the overall process of the present invention.

FIG. 3 is a continuation of FIG. 2.

FIG. 4 is a flowchart illustrating a subprocess of capturing live reaction data.

FIG. 5 is a flowchart illustrating a subprocess of capturing audio data.

FIG. 6 is a flowchart illustrating a subprocess of capturing user input data.

FIG. 7 is a flowchart illustrating a subprocess of capturing visual data.

FIG. 8 is a flowchart illustrating a subprocess of modifying visual data.

FIG. 9 is a flowchart illustrating a subprocess of accessing a social group.

FIG. 10 is a flowchart illustrating a subprocess of generating social groups.

FIG. 11 is a flowchart illustrating a subprocess of providing a content management system.

FIG. 12 is a flowchart illustrating a subprocess of generating noise.

FIG. 13 is a flowchart illustrating a subprocess of outputting live reaction data.

### DETAILED DESCRIPTION OF THE INVENTION

All illustrations of the drawings are for the purpose of describing selected versions of the present invention and are not intended to limit the scope of the present invention.

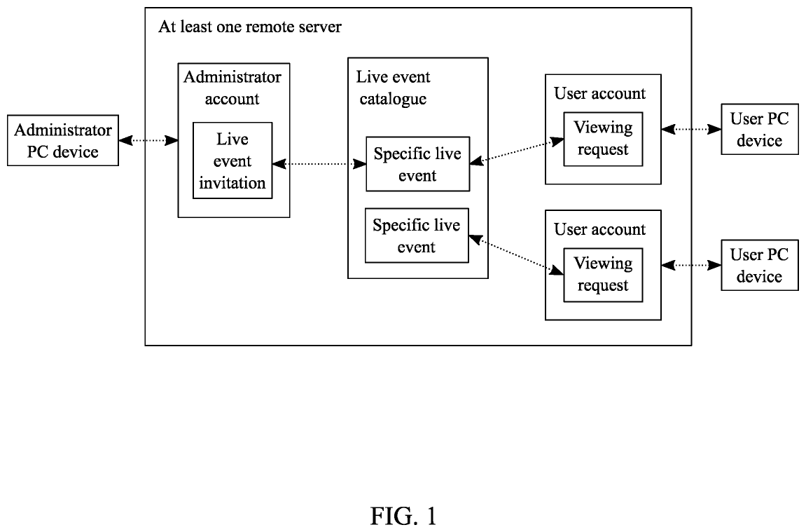

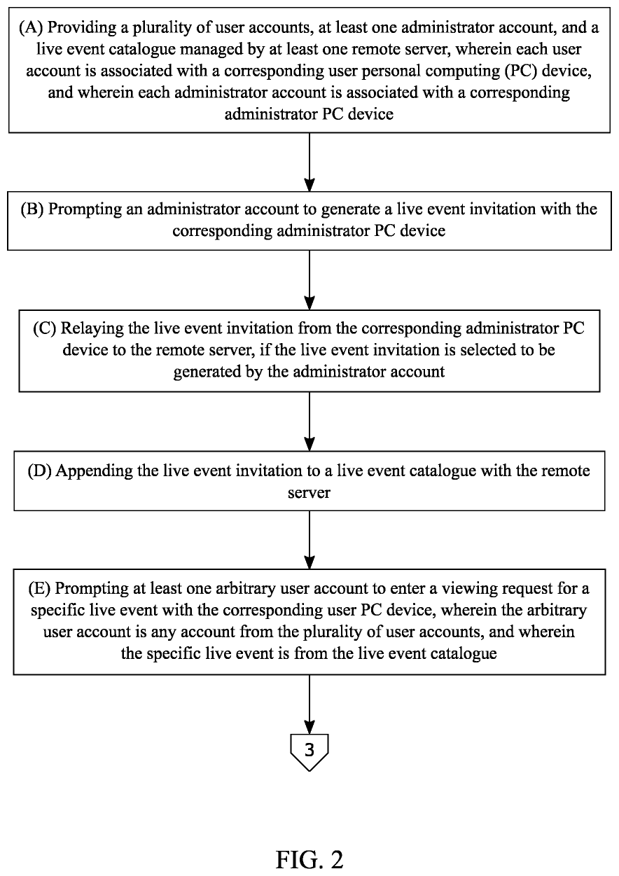

The present invention is a system and method for providing remote attendance to a live event that is designed to provide real-time fan feedback to live events, as represented in FIG. 1. The present invention accomplishes this preferably through a software application accessible through a user's computing devices. The system of the present invention includes a plurality of user accounts, at least one administrator account, and a live event catalogue managed by at least one remote server, wherein each user account is associated with a corresponding user personal computing (PC) device, and wherein each administrator account is associated with a corresponding administrator PC device (Step A), as represented in FIG. 2. The plurality of user accounts is the set of general information, including, but not limited to, names, ages, demographic data, and more, as well as any necessary credentials associated with each base user. The at least one administrator account relates to the set of general information, including, but not limited to, names, ages, demographic data, and more, as well as any necessary credentials associated with each managerial user or event orchestrator. The live event catalogue is a list of events occurring at a predetermined date and time. The at least one remote server relates to a set of wireless computing devices capable of collecting, storing, applying logic, and relaying data between wirelessly connected devices. The corresponding user PC device may be any of smartphones, laptops, desktop computers, smart devices, or a variety of other devices capable of allowing a user to wirelessly interface with the Internet. The corresponding administrator PC device may be any of smartphones, laptops, desktop computers, smart devices, or a variety of other devices capable of allowing an administrator to wirelessly interface with the Internet.

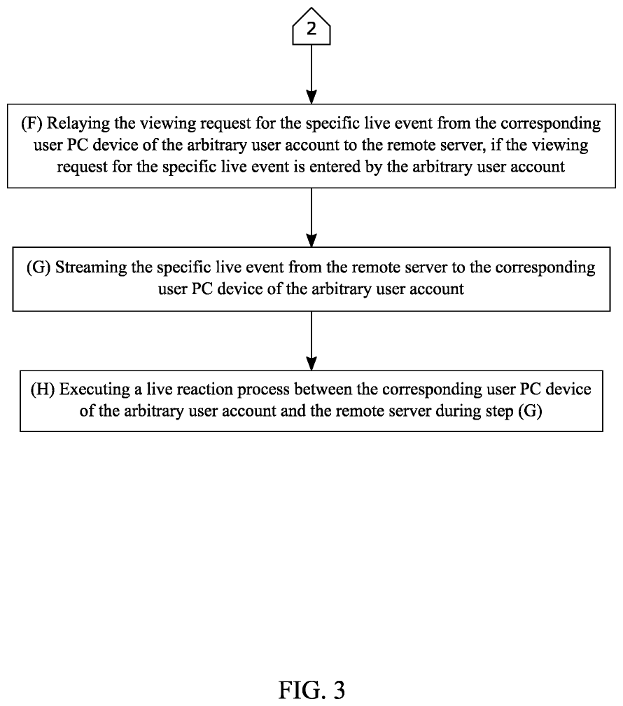

The system of the present invention as detailed above enables a user to more effectively engage with live events. An administrator account is prompted to generate a live event invitation with the corresponding administrator PC device (Step B). The live event invitation may include event details, scheduling information, and an access code or other such information necessary for distinguishing events. The live event invitation is next relayed from the corresponding administrator PC device to the remote server, if the live event invitation is selected to be generated by the administrator account (Step C). In this way, the remote server may manage, store, and otherwise apply programmatic logic to the live event invitation. The live event invitation is then appended to a live event catalogue with the remote server (Step D). The live event catalogue is the combined master schedule of events occurring at given times and in the future. The at least one arbitrary user account is next prompted to enter a viewing request for a specific live event with the corresponding user PC device, wherein the arbitrary user account is any account from the plurality of user accounts, and wherein the specific live event is from the live event catalogue (Step E). In this way, the arbitrary user account may be placed into an appropriate event or event queue during or in advance of a live event taking place. Subsequently, the viewing request for the specific live event is relayed from the corresponding user PC device of the arbitrary user account to the remote server, if the viewing request for the specific live event is entered by the arbitrary user account (Step F), as represented in FIG. 3. Therefore, the remote server may collect, manipulate, and store relevant data about the live event and the user as necessary or beneficial. The specific live event is then streamed from the remote server to the corresponding user PC device of the arbitrary user account (Step G). In this way, the arbitrary user account may view and interact with the live event. Finally, a live reaction process is executed between the corresponding user PC device of the arbitrary user account and the remote server during Step G (Step H). Thus, the remote server collects and transfers information, including, but not limited to, audio, video, textual, symbolic, and more to various connected devices within the live event.

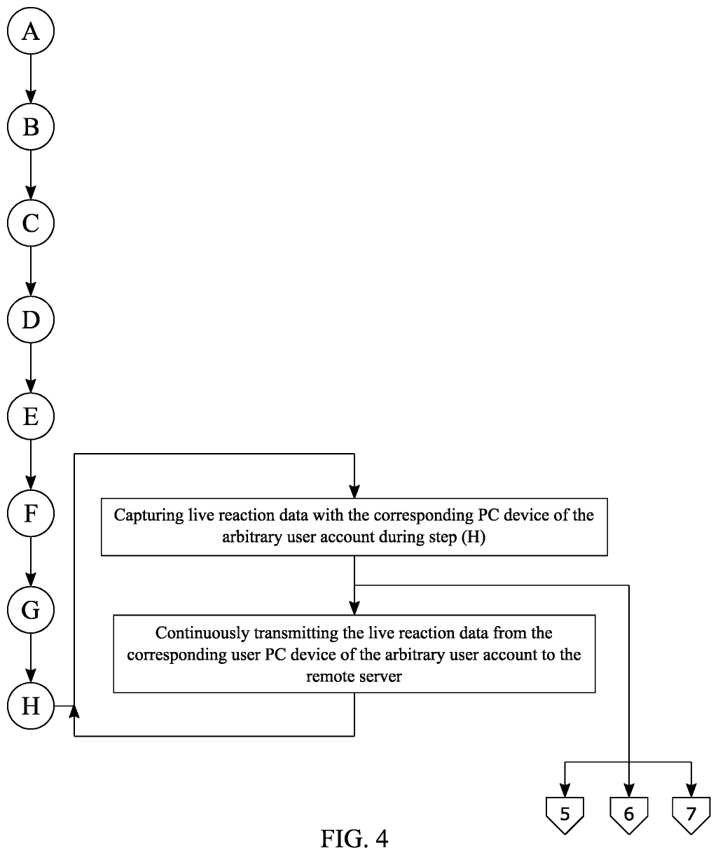

A user may wish to share any of a variety of reactions while viewing a live event. To this end, live reaction data is captured with the corresponding PC device of the arbitrary user account during Step H, as represented in FIG. 4. The live reaction data may be captured with integrated or external cameras, microphones, physical or virtual keyboards, and/or other such sensors capable of collecting significant information regarding a reaction to a live event. The live reaction data is then continuously transmitted from the corresponding user PC device of the arbitrary user account to the remote server. Thus, the remote server accesses the data from the arbitrary user account desired for communication of a reaction to an occurrence from the live event.

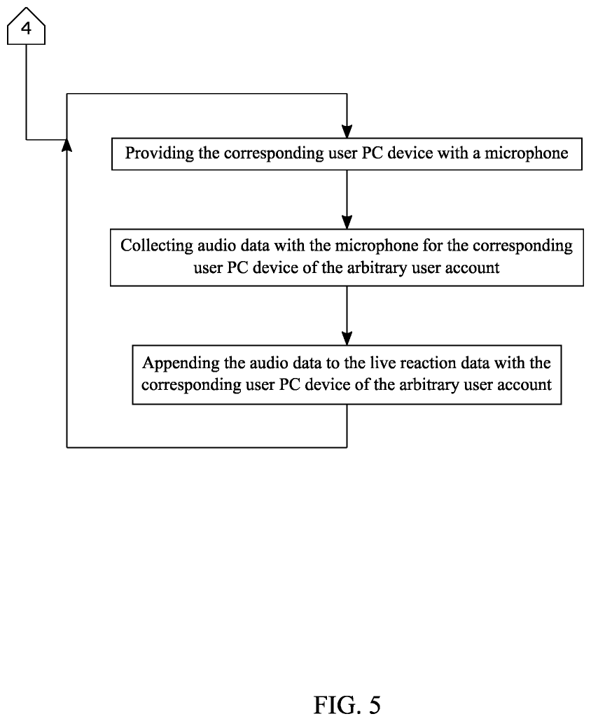

The arbitrary user account may wish to send audio data that captures part or all of the user's reaction. To allow this, the corresponding user PC device may be provided with a microphone, as represented in FIG. 5. The microphone is a sensor that converts audio waves into electronic impulses for subsequent interpretation. Audio data is then collected with the microphone for the corresponding user PC device of the arbitrary user account. This arrangement allows for subsequent relay and interpretation of the audio data produced by the arbitrary user account during a live event. Finally, the audio data is appended to the live reaction data with the corresponding user PC device of the arbitrary user account. In this way, the remote server may utilize the audio data in interpreting and presenting the reaction of the arbitrary user account.

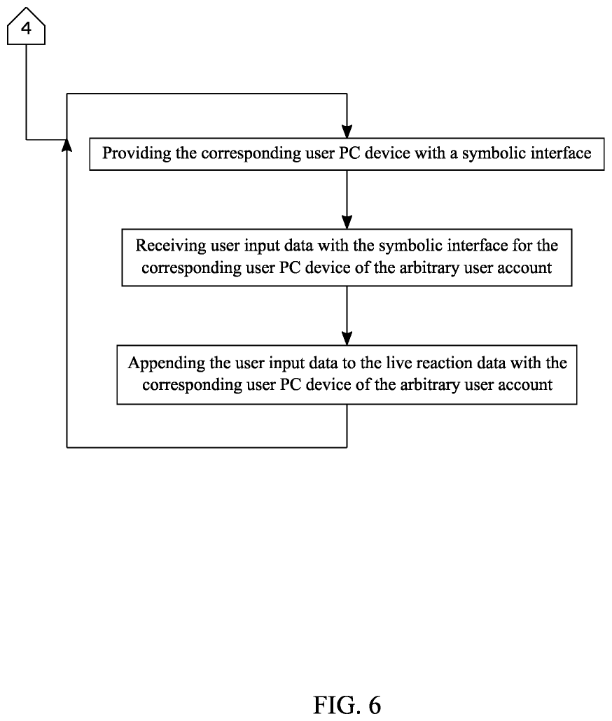

Similarly, the arbitrary user account may wish to send text or symbolic information that captures part or all of the user's reaction. To allow this, the corresponding user PC device may be provided with a symbolic interface, as represented in FIG. 6. The symbolic interface is a keyboard or other such device that enables communication of ideas, messages, and emotions through icons, alphanumeric characters, and/or emojis. User input data is then collected with the symbolic interface for the corresponding user PC device of the arbitrary user account. This arrangement allows for subsequent interpretation of text, symbols, and emojis produced by the arbitrary user account during a live event. Finally, the user input data is appended to the live reaction data with the corresponding user PC device of the arbitrary user account. In this way, the remote server may now utilize the user input data in interpreting and presenting the reaction of the arbitrary user account.

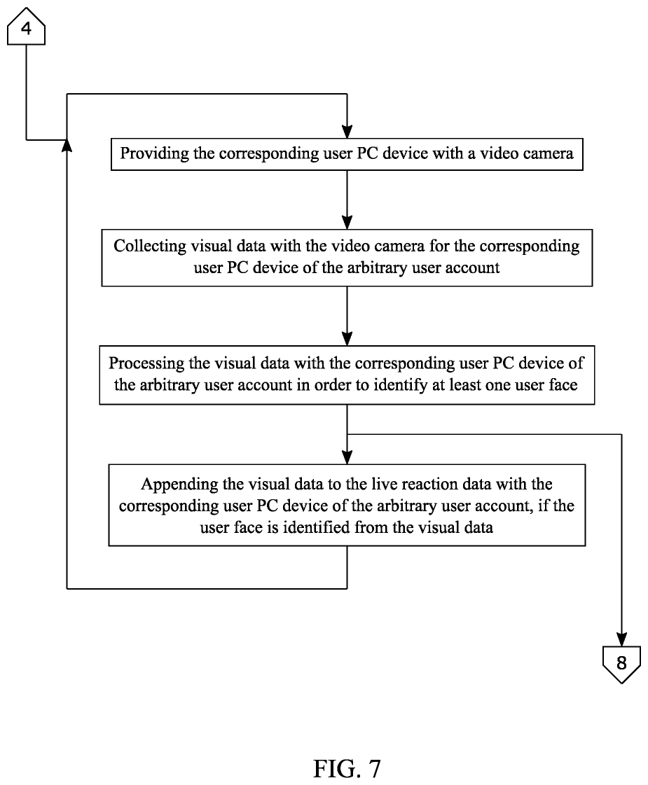

Furthermore, the arbitrary user account may wish to send picture or video information that captures part or all of the user's reaction. To allow this, the corresponding user PC device may be provided with a video camera, as represented in FIG. 7. The video camera is a device capable of capturing and electronically relaying visual information about the arbitrary user account and the arbitrary user account's surroundings. Visual data is then collected with the video camera for the corresponding user PC device of the arbitrary user account. This arrangement allows for subsequent interpretation of video and images produced by the arbitrary user account during a live event. The visual data is next processed with the corresponding user PC device of the arbitrary user account in order to identify at least one user face. The at least one user face is the set of faces, especially human faces, identified, ideally through application of any recently developed external facial recognition software. Finally, the visual data is appended to the live reaction data with the corresponding user PC device of the arbitrary user account, if the user face is identified from the visual data. In this way, the remote server may now utilize the visual data in interpreting and presenting the reaction of the arbitrary user account upon identification of a user's face.

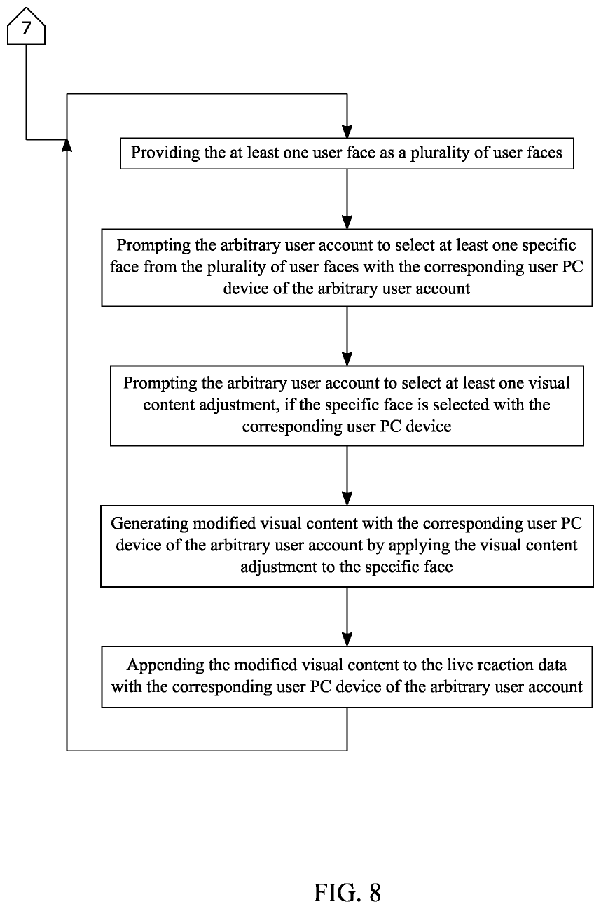

In a room full of acquaintances, user engagement may be improved by allowing users to manipulate or adjust the appearance of faces in the room. Furthermore, facial recognition may enable conditional access to private features as preferred by the arbitrary user account. To allow this, the at least one user face may be provided as a plurality of user faces, as represented in FIG. 8. This arrangement ensures that there are multiple people identified in the visual data. The arbitrary user account is then prompted to select at least one specific face from the plurality of user faces with the corresponding user PC device of the arbitrary user account. In this way, the arbitrary user account can apply a filter to a specific face among all of the present faces. Next, the arbitrary user account is prompted to select at least one visual content adjustment, if the specific face is selected with the corresponding user PC device. The visual content adjustment may include, but is not limited to, any or any combination of shading, tone, blur, feature shape, feature size, or other adjustments, as well as additions of external features. Modified visual content is subsequently generated with the corresponding user PC device of the arbitrary user account by applying the visual content adjustment to the specific face. This arrangement ensures that the appropriate face is manipulated according to the visual content adjustment during the application of filters and other such visual adjustments. Finally, the modified visual content is appended to the live reaction data with the corresponding user PC device of the arbitrary user account. Thus, the modified visual content is made available to the remote server for subsequent manipulation and appropriate distribution.

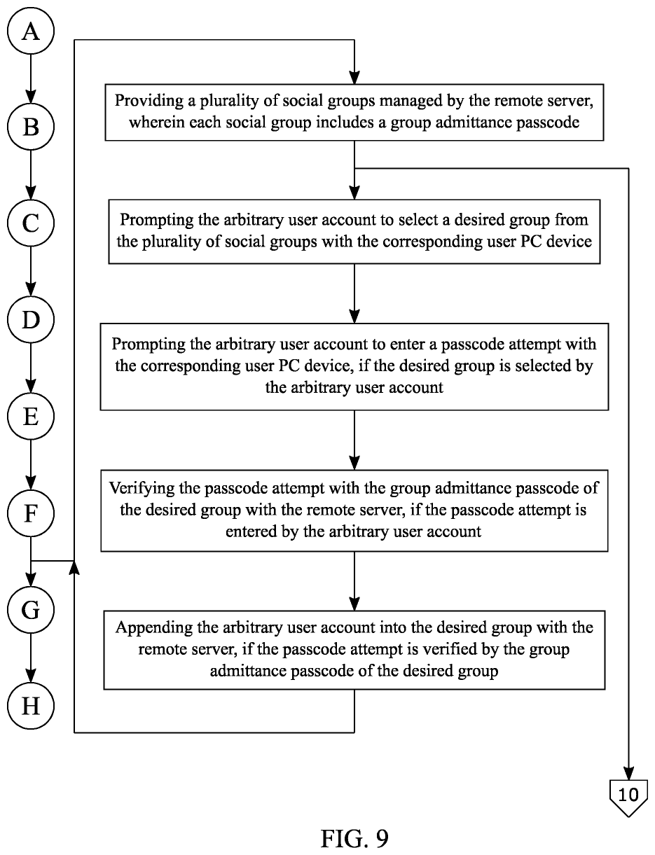

Users may wish to join their friends for more exclusive participation in a live event. To this end, a plurality of social groups may be provided and managed by the remote server, wherein each social group includes a group admittance passcode, as represented in FIG. 9. The plurality of social groups relates to the set of available subdivisions of the plurality of user accounts within a live event. The arbitrary user account is prompted to select a desired group from the plurality of social groups with the corresponding user PC device. This arrangement allows the arbitrary user account to identify the appropriate social group that the arbitrary user account wishes to join. The arbitrary user account is next prompted to enter a passcode attempt with the corresponding user PC device, if the desired group is selected by the arbitrary user account. In this way, the social group has the ability to restrict the number of user accounts that may enter to a select few desired user accounts. The passcode attempt is then verified with the group admittance passcode of the desired group with the remote server, if the passcode attempt is entered by the arbitrary user account. This arrangement prevents unauthorized user accounts from entering the social group. Finally, the arbitrary user account is appended into the desired group with the remote server, if the passcode attempt is verified by the group admittance passcode of the desired group. Thus, the arbitrary user account may join acquaintances in private lobbies during a live event.

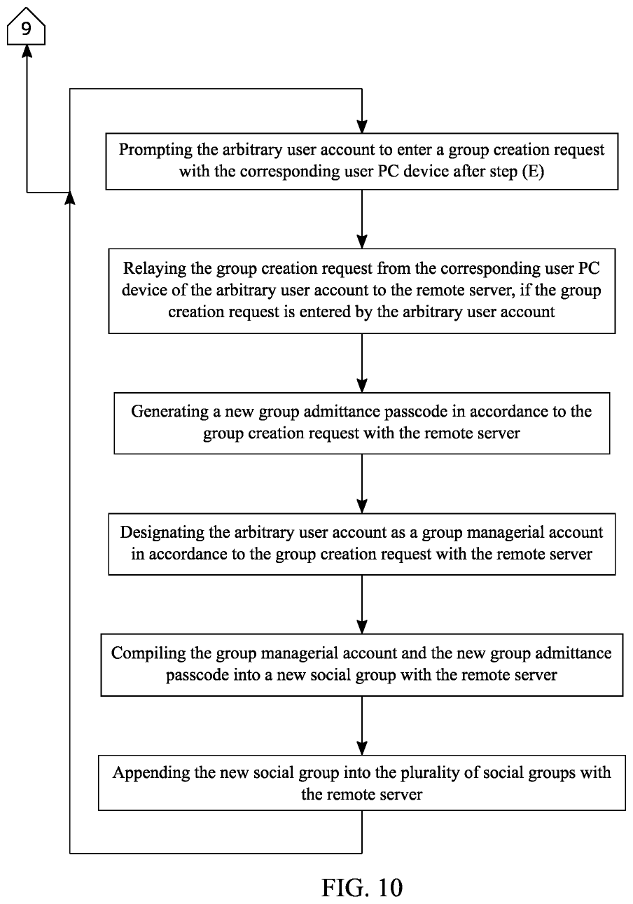

The arbitrary user account may wish to establish and manage their own social group. To this end, the arbitrary user account is prompted to enter a group creation request with the corresponding user PC device after Step E, as represented in FIG. 10. The group creation request may include features such as group name, group maximum size, invitees, event information, and more. The group creation request is then relayed from the corresponding user PC device of the arbitrary user account to the remote server, if the group creation request is entered by the arbitrary user account. This arrangement allows the remote server to disseminate the group creation request appropriately. A new group admittance passcode is then generated in accordance to the group creation request with the remote server. The new group admittance passcode may meet desired requirements, such as combinations of alphanumeric characters, allowable punctuation, minimum length, capitalization, and more. The arbitrary user account is designated as a group managerial account in accordance to the group creation request with the remote server. In this way, the group managerial account may be given special privileges with respect to managing users within the social group. The group managerial account and the new group admittance passcode are next compiled into a new social group with the remote server. The new social group includes all of the preferences assigned by the group managerial account. Finally, the new social group is appended into the plurality of social groups with the remote server. In this way, the new social group is made accessible to users searching through the plurality of social groups.

A user may wish to hear and experience the live event data without interacting with the plurality of user accounts. To this end, the live event audiovisual data is outputted with the corresponding user PC device after Step H. In this way, a user may watch the live event without actively participating or providing live reaction data to the remote server.

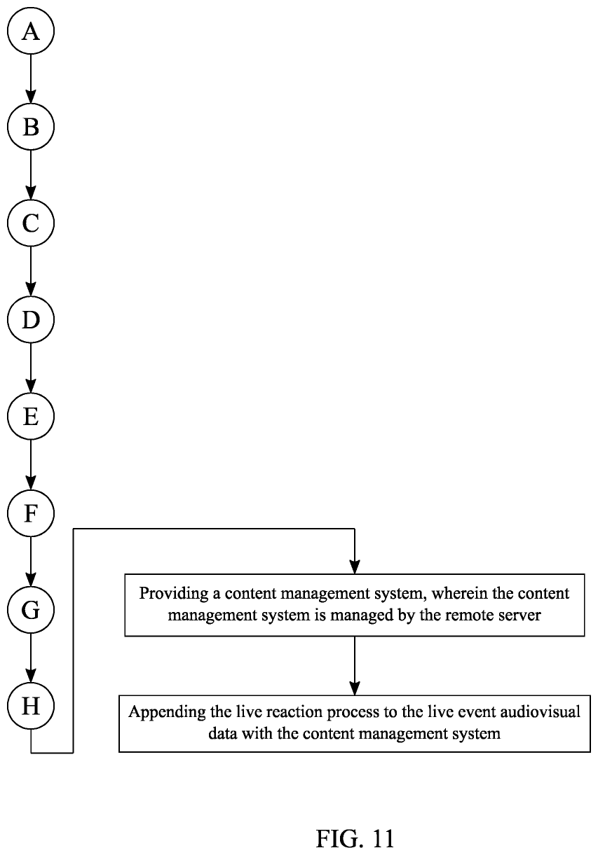

It may be further desirable to supplement multimedia data from the live event with various fan reactions. To enable this, a content management system may be provided, wherein the content management system is managed by the remote server, as represented in FIG. 11. The content management system collects, arranges, and stores the live reaction data as the live reaction data is provided. The live reaction process is then appended to the live event audiovisual data with the content management system. Thus, users may view not only the event, but also chosen or interpreted content from the plurality of user accounts.

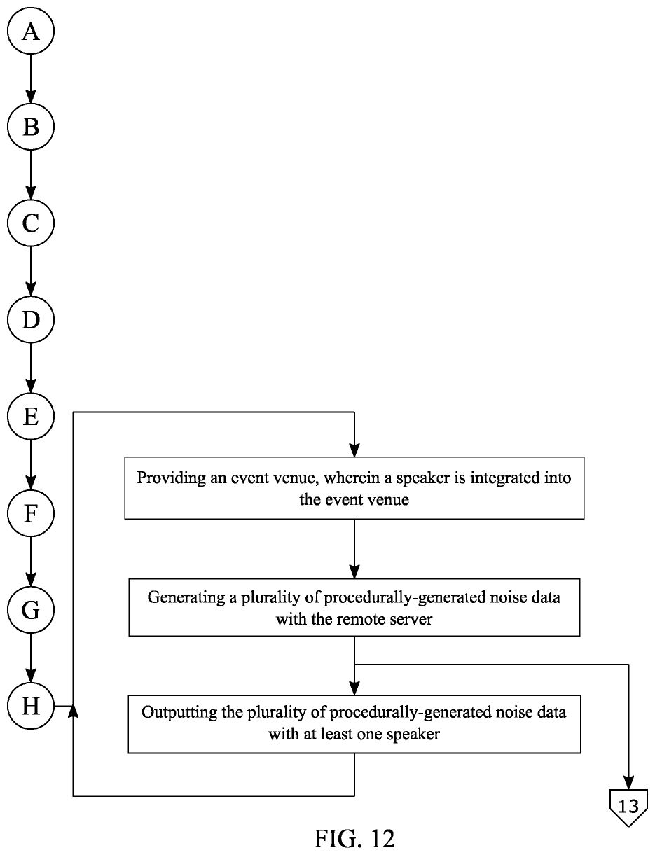

In otherwise-empty event venues, it may be desirable to increase the ambient volume in order to increase remote fan engagement. To enable this, an event venue is provided, wherein a speaker is integrated into the event venue, as represented in FIG. 12. The event venue is the location at which a live event is taking place. The speaker is a device capable of outputting appropriate audio waves by translating electronic signal inputs. A plurality of procedurally-generated noise data is then generated with the remote server. In this way, the atmosphere of a packed stadium or venue can be mimicked artificially. Finally, the plurality of procedurally-generated noise data may be outputted with at least one speaker. Thus, the event venue is filled with sound corresponding to automatically-generated noise from the present invention.

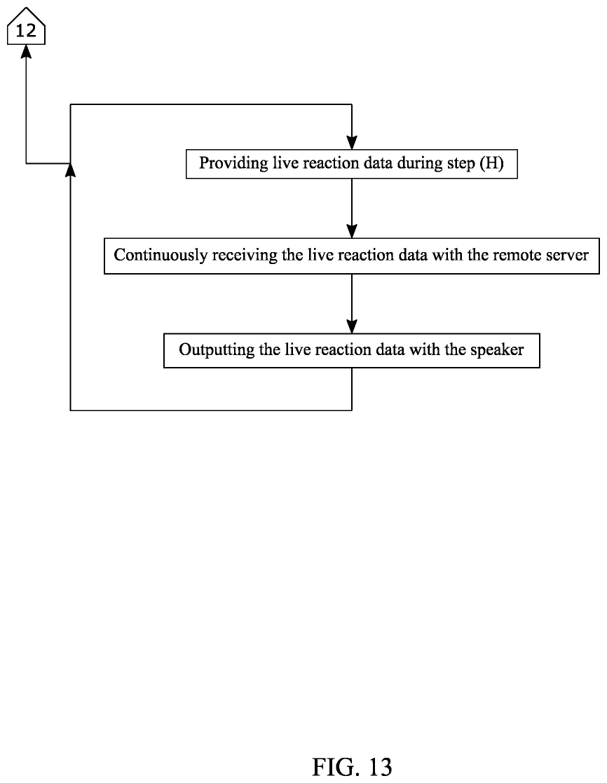

Furthermore, it may be desirable to project the live reaction data along with procedurally-generated noise. To enable this, the live reaction data may be provided during Step H, as represented in FIG. 13. In this way, live reaction data may be made accessible to the remote server during projection of noise. The live reaction data is then continuously received with the remote server. Thus, the remote server may arrange, store, and otherwise manage the live reaction data as necessary. Finally, the live reaction data is outputted with the speaker. In this way, the plurality of user accounts may have their audio data projected out towards performers and entertainers during a show, mimicking a true live performance experience.

Although the invention has been explained in relation to its preferred embodiment, it is to be understood that many other possible modifications and variations can be made without departing from the spirit and scope of the invention as hereinafter claimed.

What is claimed is:

1. A method for providing remote attendance to a live event, the method comprises the steps of:
(A) providing a plurality of user accounts, at least one administrator account, and a live event catalogue managed by at least one remote server, wherein each user account is associated with a corresponding user personal computing (PC) device, and wherein each administrator account is associated with a corresponding administrator PC device;
(B) prompting an administrator account to generate a live event invitation with the corresponding administrator PC device;
(C) relaying the live event invitation from the corresponding administrator PC device to the remote server, if the live event invitation is selected to be generated by the administrator account;
(D) appending the live event invitation to a live event catalogue with the remote server;
(E) prompting at least one arbitrary user account to enter a viewing request for a specific live event with the corresponding user PC device, wherein the arbitrary user account is any account from the plurality of user accounts, and wherein the specific live event is from the live event catalogue;
(F) relaying the viewing request for the specific live event from the corresponding user PC device of the arbitrary user account to the remote server, if the viewing request for the specific live event is entered by the arbitrary user account;
(G) streaming the specific live event from the remote server to the corresponding user PC device of the arbitrary user account; and
(H) executing a live reaction process between the corresponding user PC device of the arbitrary user account and the remote server during step (G).

2. The method for providing remote attendance to a live event, the method as claimed in claim 1 comprises the steps of:
capturing live reaction data with the corresponding PC device of the arbitrary user account during step (H); and
continuously transmitting the live reaction data from the corresponding user PC device of the arbitrary user account to the remote server.

3. The method for providing remote attendance to a live event, the method as claimed in claim 2 comprises the steps of:
providing the corresponding user PC device with a microphone;
collecting audio data with the microphone for the corresponding user PC device of the arbitrary user account; and
appending the audio data to the live reaction data with the corresponding user PC device of the arbitrary user account.

4. The method for providing remote attendance to a live event, the method as claimed in claim 2 comprises the steps of:
providing the corresponding user PC device with a symbolic interface;
receiving user input data with the symbolic interface for the corresponding user PC device of the arbitrary user account; and
appending the user input data to the live reaction data with the corresponding user PC device of the arbitrary user account.

5. The method for providing remote attendance to a live event, the method as claimed in claim 2 comprises the steps of:
providing the corresponding user PC device with a video camera;
collecting visual data with the video camera for the corresponding user PC device of the arbitrary user account;
processing the visual data with the corresponding user PC device of the arbitrary user account in order to identify at least one user face; and
appending the visual data to the live reaction data with the corresponding user PC device of the arbitrary user account, if the user face is identified from the visual data.

6. The method for providing remote attendance to a live event, the method as claimed in claim 5 comprises the steps of:
providing the at least one user face as a plurality of user faces;
prompting the arbitrary user account to select at least one specific face from the plurality of user faces with the corresponding user PC device of the arbitrary user account;
prompting the arbitrary user account to select at least one visual content adjustment, if the specific face is selected with the corresponding user PC device;
generating modified visual content with the corresponding user PC device of the arbitrary user account by applying the visual content adjustment to the specific face; and
appending the modified visual content to the live reaction data with the corresponding user PC device of the arbitrary user account.

7. The method for providing remote attendance to a live event, the method as claimed in claim 1 comprises the steps of:
providing a plurality of social groups managed by the remote server, wherein each social group includes a group admittance passcode;
prompting the arbitrary user account to select a desired group from the plurality of social groups with the corresponding user PC device;
prompting the arbitrary user account to enter a passcode attempt with the corresponding user PC device, if the desired group is selected by the arbitrary user account;
verifying the passcode attempt with the group admittance passcode of the desired group with the remote server, if the passcode attempt is entered by the arbitrary user account; and
appending the arbitrary user account into the desired group with the remote server, if the passcode attempt is verified by the group admittance passcode of the desired group.

8. The method for providing remote attendance to a live event, the method as claimed in claim 7 comprises the steps of:
prompting the arbitrary user account to enter a group creation request with the corresponding user PC device after step (E);
relaying the group creation request from the corresponding user PC device of the arbitrary user account to the remote server, if the group creation request is entered by the arbitrary user account;
generating a new group admittance passcode in accordance to the group creation request with the remote server;
designating the arbitrary user account as a group managerial account in accordance to the group creation request with the remote server;
compiling the group managerial account and the new group admittance passcode into a new social group with the remote server; and
appending the new social group into the plurality of social groups with the remote server.

9. The method for providing remote attendance to a live event, the method as claimed in claim 1, wherein the live event audiovisual data is outputted with the corresponding user PC device after step (H).

10. The method for providing remote attendance to a live event, the method as claimed in claim 9 comprises the steps of:
providing a content management system, wherein the content management system is managed by the remote server; and
appending the live reaction process to the live event audiovisual data with the content management system.

11. The method for providing remote attendance to a live event, the method as claimed in claim 1 comprises the steps of:
providing an event venue, wherein a speaker is integrated into the event venue;
generating a plurality of procedurally-generated noise data with the remote server; and
outputting the plurality of procedurally-generated noise data with at least one speaker.

12. The method for providing remote attendance to a live event, the method as claimed in claim 11 comprises the steps of:
providing live reaction data during step (H);
continuously receiving the live reaction data with the remote server; and
outputting the live reaction data with the speaker.
